(19) United States
(12) Patent Application Publication
(10) Pub. No.: US 2016/0023701 A1
(43) Pub. Date: Jan. 28, 2016

(54) LOCALIZED MOTION CONVEYOR FOR VEHICLE CARRIER

(71) Applicant: GM Global Technology Operations LLC, Detroit, MI (US)

(72) Inventor: Wade W. Bryant, Grosse Pointe Farms, MI (US)

(21) Appl. No.: 14/338,415

(22) Filed: Jul. 23, 2014

(51) Int. Cl. B62D 65/18; B60L 11/18

(52) U.S. Cl. CPC B62D 65/18; B60L 11/1809

(57) ABSTRACT

A number of variations may include a method including providing a conveyor which may be constructed and arranged to move a Personal Electric Vehicle (PEV). A fully loaded PEV Host may be moved to a first location, wherein the PEV Host may include a carry platform. At least one PEV from the PEV Host may be removed at a first location. The remaining PEVs may be laterally moved across the carry platform in order to compact the load. Additional PEVs from the conveyor may be added to the carrying platform. Finally, the PEV Host may be moved to a second location wherein at least one PEV from the PEV Host is removed at the second location.

### TECHNICAL FIELD

The field to which the disclosure generally relates to includes vehicle production systems including vehicle transport systems.

### BACKGROUND

Vehicle production mechanisms may have various conveyers to move a vehicle during the production process.

### SUMMARY OF ILLUSTRATIVE VARIATIONS

A number of variations may include a method which may comprise providing a conveyor constructed and arranged to move a Personal Electric Vehicle (PEV). Next, moving a fully loaded PEV Host to a first location, wherein the PEV Host includes a carry platform. Additionally, removing at least one PEV from the PEV Host at the first location. Next, the remaining PEVs are laterally moved along the carry platform in order to compact the load. Moreover, additional PEVs are loaded from the conveyor onto the carrying platform of the PEV Host. The entire PEV Host is then moved to a second location. At least one PEV is removed from the PEV Host at the second location.

A number of other variations may include a method which may comprise first moving a Personal Electric Vehicle (PEV) Host to a first location, wherein the PEV Host includes at least one PEV disposed on a carry platform. Next, at least one PEV is removed from the PEV Host at a first location. Additionally, at least one PEV is moved laterally along the carry platform in order to compact the load. Next, at least one PEV from the conveyor is loaded onto the carrying platform of the PEV Host. Additionally, the PEV Host is then moved to a second location. Finally, at least one PEV from the PEV Host is removed at a second location.

Yet another variation may include a method which may comprise providing a conveyor constructed and arranged to move a Personal Electric Vehicle (PEV). Next, a fully loaded PEV Host is moved to a first location where the PEV Host may include a carry platform. Next, at least one of the PEVs may be removed from the PEV Host at the first location. Next, the remaining PEVs may be moved laterally across the carry platform in order to compact the load. The lateral movement may be done by a mechanical conveyor which may have individually rotating units which may be constructed and arranged to move the PEVs laterally across the carry platform. Next, additional PEVs may be loaded from the conveyor to the carrying platform of the PEV Host. Next, the PEV Host may be moved to a second location where at least one PEV may be removed from the PEV Host.

Other illustrative variations within the scope of the invention will become apparent from the detailed description provided hereinafter. It should be understood that the detailed description and specific examples, while disclosing variations within the scope of the invention, are intended for purposes of illustration only and are not intended to limit the scope of the invention.

### BRIEF DESCRIPTION OF THE DRAWINGS

Select examples of variations within the scope of the invention will become more fully understood from the detailed description and the accompanying drawings, wherein:

FIG. 1 shows a schematic illustration of a vehicle production system according to a number of variations;

FIG. 2 shows a top plan view of a portion of the vehicle production system according to a number of variations;

FIG. 3 shows a side plan view of the vehicle production system according to a number of variations;

FIG. 4 shows a side view of another portion of the vehicle production system according to a number of variations;

FIG. 5 shows a side view of a portion of the vehicle production system according to a number of variations;

FIG. 6 shows a side perspective view of a portion of FIG. 2 according to a number of variations;

FIG. 7 shows a close up view of a portion of FIG. 6 according to a number of variations; and

FIG. 8 shows an end view of the vehicle production system according to a number of variations.

### DETAILED DESCRIPTION OF ILLUSTRATIVE VARIATIONS

The following description of the variations is merely illustrative in nature and is in no way intended to limit the scope of the invention, its application, or uses.

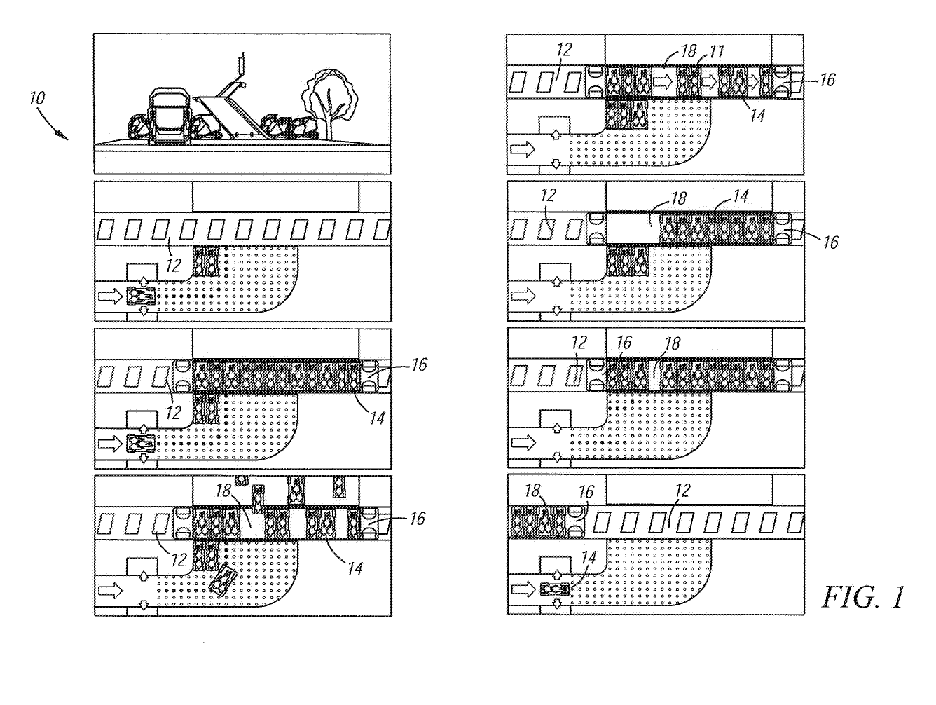

Referring to FIGS. 1-8, a method of providing a localized motion conveyor 10 for vehicle carrier may include providing a conveyor 12 constructed and arranged to move a Personal Electric Vehicle (PEV) 14. Additionally, a fully loaded PEV Host 16 may be moved to a first location 20. The PEV Host 16 may also include a carry platform 18. Next, at least one PEV 14 may be removed from the PEV Host 16 at the first location 20. Moreover, the remaining PEVs 14 may be laterally moved along the carry platform 18 in order to compact the load. Additional PEVs 14 may be loaded from the conveyor 12 to the carry platform 18 of the PEV Host 16. The PEV Host 16 may then be moved to a second location 22 wherein at least one PEV 14 may be removed from the PEV Host 16.

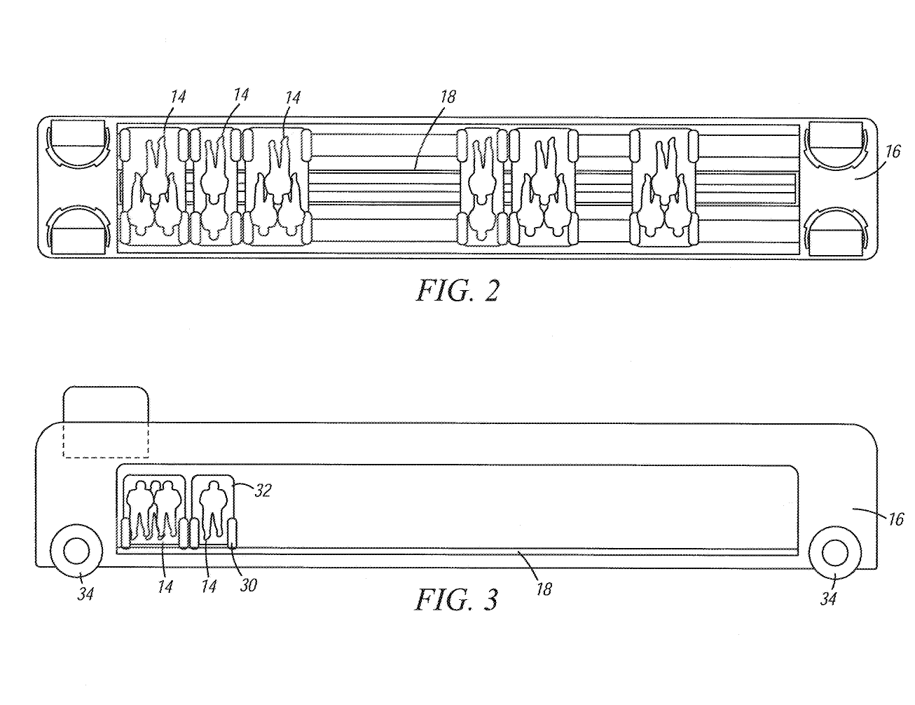

Referring now to FIGS. 1 and 2, the Personal Electric Vehicle 14 may be a small car or vehicle that may be carried on a larger PEV Host. The larger PEV Host 16 may include but is not limited to a road, rail, water or air based vehicle. The Personal Electric Vehicles 14 may be built to accommodate various Hosts. As such, the Personal Electric Vehicles 14 may have various size standards along with variable widths depending on consumer needs. The PEV 14 may generally include at least one tire 30 along with a vehicle body 32. Moreover, the conveyor 12 may also include the PEV Host 16. The PEV Host 16 may be a vehicle which may be designed to transport various types of PEVs 14. The PEV Host 16 may have a dedicated carry platform 18 which may allow PEVs 14 to embark, lock down, and/or electrically charge while being carried to a destination where they may disembark and then drive to an ultimate destination. As illustrated in the variations shown in FIGS. 2 and 3, the PEV Host 16 may be a generally rectangular Host which may include at least one wheel 34 in order to facilitate transport of the Host. The PEV Host 16 may also include a driver 36 which may be configured to drive the PEV Host 16 from the first location 20 to the second location 22 and may be driven to various other locations as decided by a user or as decided by a preset criteria. It is contemplated that the driver 36 may be a preprogrammed driver 36 such that the driver 36 operates automatically. It is also contemplated that the driver 36 may be controlled by a user.

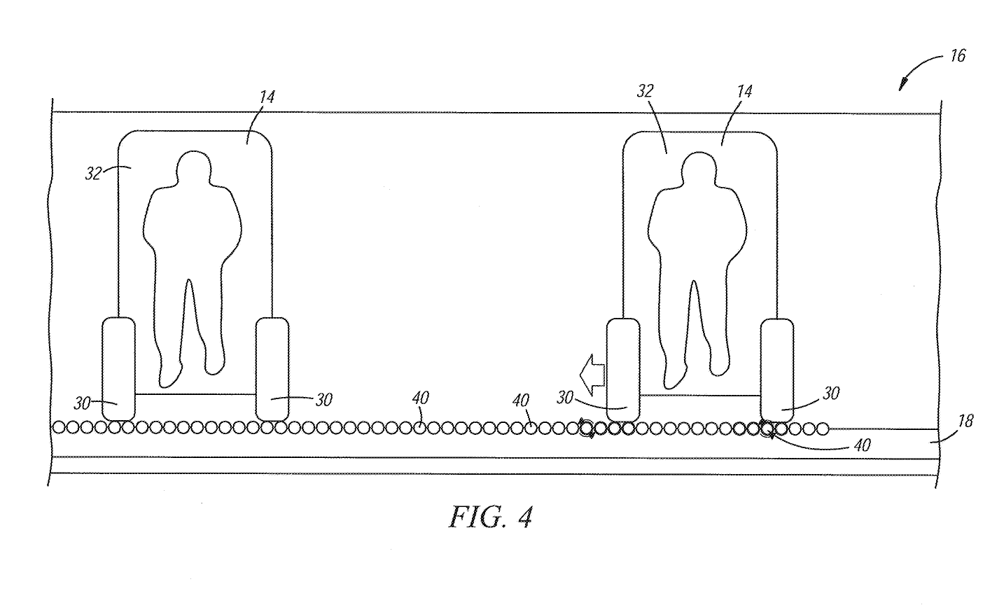

As illustrated in the variations shown in FIGS. 2 and 3, the carry platform 18 may be disposed in a recessed portion of the PEV Host 16. It is also contemplated that the carry platform 18 may be disposed on top of or otherwise adjacent to the PEV Host 16. The carry platform 18 may come into abutting contact with the tires of the PEV 14. As shown in FIGS. 2 and 4, the carry platform 18 may further include the localized motion variable speed conveyor 12. The localized motion variable speed conveyor 12 may be a multicomponent mechanical conveyor which may include individually activated rotating units or actuators 40. The actuators 40 may be configured to move PEVs 14 laterally along the carry platform 18 in order to compact the load when desired.

As illustrated in the variations shown in FIGS. 4-7, the individual activators 40 may be in abutting contact with the tires 30 of the PEV 14. The actuators 40 may then be activated to rotate simultaneously to move selected PEVs 14 laterally along the carry platform 18 in order to reduce space between each PEV 14. The actuators 40 may be individually controlled such that each actuator may be activated or inactive in order to allow the selected PEVs 14 to move laterally, or to allow the well positioned PEVs 14 to remain in their location. The individually controlled actuators 40 may allow PEVS 14 of various widths to move laterally and compact as desired.

The carry platform 18 may also include a PEV lockdown and positioning system 46. The PEV lockdown and positioning system 46 may be mechanical interface which may lock PEV 14 onto the Host 16 for transport. During lateral movement by the PEVs 14, the lockdown and positioning system 46 allows the lateral movement of the PEV 14 while controlling the fore/aft position of the PEV 14 on the PEV Host 16 to maintain stability.

As illustrated in the variation shown in FIG. 4, the individually rotating actuators 40 may be independently driven subunits of the conveyor 12. It is also contemplated that the individually rotating actuators 40 may act upon the tires 30 of the PEV 14 in order to move the PEVs 14 laterally along the carry platform 18. The individually rotating actuators 40 may rotate as required to simultaneously move selected PEVs 14 laterally along the carry platform 18 in order to reduce space between each PEV 14. It is also contemplated that the individual rotating actuators 40 may move selected PEVs 14 in a preselected or random order as desired by a user. Some of the individually rotating actuators 40 may be inactive in order to allow well positioned PEVs 14 to remain in place. It is also contemplated that the individually rotating actuators 40 may be in abutting contact with the tire 30 of the PEV 14 in order to move the PEV 14 into a desired position on the carry platform 18.

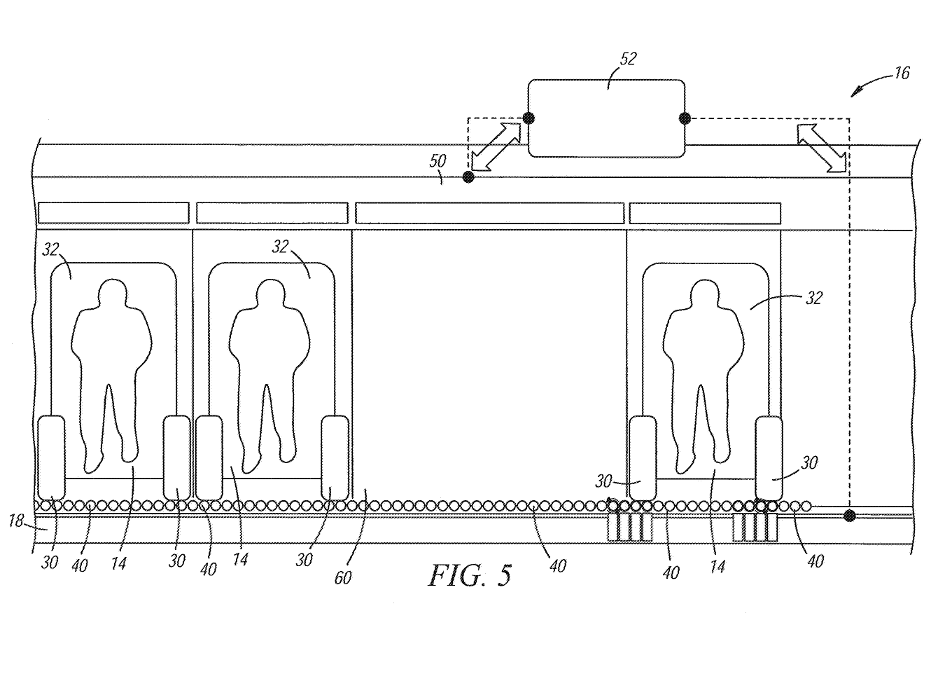

As illustrated in the variations shown in FIGS. 4 and 5, the individually rotating actuators 40 may be controlled by a PEV detection system 50. The PEV detection system 50 may be constructed and arranged to locate and monitor PEVs 14 on the carry platform 18. The PEV detection system 50 may also detect foreign objects on the carry platform 18 in order to prevent an obtrusion of the carry platform 18. It is also contemplated that a load optimization system 52 may be operably coupled to the carry platform 18. The load optimization system 52 may be a computer or another electronic communication device which may be configured to control the individually rotating actuators 40 and the position of the PEVs 14 on the carry platform 18.

Additionally, the carry platform 18 may be operably coupled to a motion actuator control system 54 which may be constructed and arranged to activate each of the individually rotating actuators 40 and may have a mechanical or electrical engagement. It is contemplated that the PEV detection system 50 may scan a floor of the carry platform 18 and may be configured to identify the location of each PEV 14 along with any voids on the individually rotating actuators 40. The PEV detection system 50 may be a radio, laser, sonar, visual, or other based system as known by one of ordinary skill in the art for identifying object positions on a carry platform 18.

As illustrated in the variation shown in FIG. 5, in operation, the carry platform 18 may begin at a first location 20 where it is contemplated that some of the PEVs 14 may disembark. Once some of the PEVs 14 disembark, a gap space 60 may be formed on the carry platform 18. The PEV detection system 50 may be configured to locate and monitor PEVs 14 and/or foreign objects which may be disposed on the carry platform 18. It is contemplated that the PEV detection system 50 may relay this information to the load optimization system 52. The load optimization system 52 may take the data determined by the PEV detection system 50 and may electronically deliver the data to the motion actuator control system 54. The motion actuator control system 54 then may activate individual motion actuators 40 based on the information given by the detection system 50 and the load optimization system 52 and may move each PEV 14 laterally into an optimized position. Once the PEVs 14 are moved into an optimized position, additional PEVs 14 can embark in the open spaces.

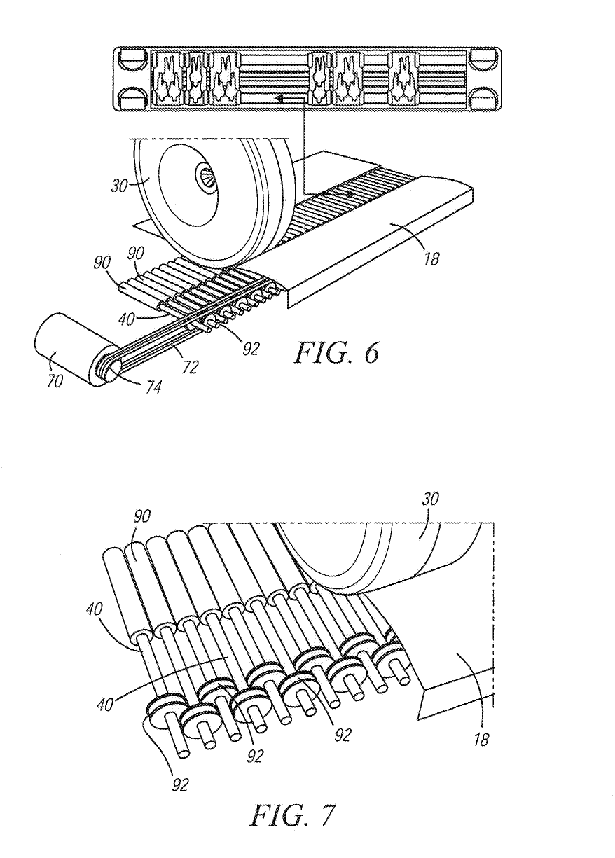

Referring now to the variation illustrated in FIG. 6, the carry platform 18 may include additional features such as a central drive motor 70, power transfer pulley/gears 72, clutches 74, belts 76, a load platform 78, and internal solenoid clutches 80. It is also contemplated that additional features may be included in the carry platform 18 as known by one of ordinary skill in the art. The load platform 78 may be constructed and arranged to be disposed over the individually rotating actuators 40. As illustrated in the variation shown in FIG. 6, the load platform 78 may have an aperture or may be two or more separate pieces which allow the individually rotating actuators 40 to be exposed.

It is contemplated that the exposure of the individually rotating actuators 40 may be centrally disposed on the carry platform 18. It is also contemplated that the exposed internally rotating actuators 40 may be disposed on a front or rear or any other side of the carry platform 18 as desired by one of ordinary skill in the art. The central drive motor 70 may also be disposed under the load platform 78, or may be disposed adjacent to the load platform 78 as known by one of ordinary skill in the art. It is contemplated that the central drive motor 70 may supply power to each of the individually rotating actuators 40 via belt, chain, or other method as known by one of ordinary skill in the art. It is also contemplated that pulley 72, shaft, clutches 74 or belts 76 may be covered by the load platform 78. As illustrated in FIG. 6, the pulleys 72 or belt/chains may be connected to the central drive motor 70.

Referring now to the variations illustrated in FIGS. 6 and 7, it is contemplated that the individually rotating actuators 40 may be generally cylindrical units having one or more protrusion. A first protrusion 90 may be cylindrical in shape as illustrated in FIG. 7 and may be configured to come into contact with a tire 30 of the PEV 14. Additionally, the individually rotating actuators 40 may have a second protrusion 90 which may be generally circular or any other shape as known by one of ordinary skill in the art in order to allow the pulley/gears 72 or belt/chain 76 to be connected to the drive motor 70 and the individually rotating actuators 40. It is also contemplated that the individually rotating actuators 40 may include the internal solenoid clutch 80 which may be configured to engage and disengage individually rotating actuators 40.

As illustrated in FIG. 7, it is contemplated that the second protrusion 92 and internal solenoid clutches 80 may be staggered and/or may be disposed on alternating individually rotating actuators 40 such that more than one belt/chain 76 and pulley/gear 72 may be connected to the central drive motor 70 and to the individually rotating actuators 40. It is also contemplated that another configuration of protrusions 90, 92 and internal solenoid clutches 80 may be present on the individually rotating actuators 40 as known by one of ordinary skill in the art.

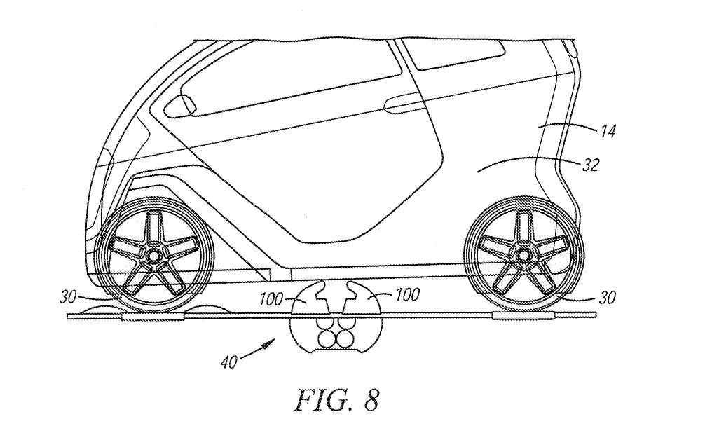

Referring now to the variation illustrated in FIG. 8, the carry platform 18 may also include the PEV lockdown system 46. The lockdown system 46 may include lockdown feet 100 which may deploy from either below the PEV 14 or from the carry platform 18 in order to provide a secure connection to the carry platform 18. It is contemplated that the lockdown system 46 may include at least three distinct positions. The first position is a retracted position 102 in which the lockdown feet 100 are retracted below the carry platform 18. The second position may be a lockdown position 104 in which the feet 100 are in a full up position and may clamp the PEV 14 in place. It is contemplated that when the PEV 14 is in the lockdown position 64, the PEV 14 may be operably coupled to an electronic charging system such that the PEV 14 may be charged. The third position may be a guide position 106 in which the lockdown feet 102 are up however the lockdown feet 102 are not attached to the PEV 14. The guide position 106 may enable the PEV 14 to be laterally shuffled by the individually rotating actuators 40 while maintaining a fore/aft position on the carry platform 18.

The following description of variants is only illustrative of components, elements, acts, product and methods considered to be within the scope of the invention and are not in any way intended to limit such scope by what is specifically disclosed or not expressly set forth. The components, elements, acts, product and methods as described herein may be combined and rearranged other than as expressly described herein and still are considered to be within the scope of the invention.

Variation 1 may include a method which may comprise providing a conveyor constructed and arranged to move a Personal Electric Vehicle, moving a fully loaded PEV Host to a first location wherein the PEV Host may include a carry platform. Next, at least one PEV may be removed from the PEV Host at the first location. The remaining PEVs may then be laterally moved along the carry platform in order to compact the load. Additional PEVs may be loaded from the conveyor to the carrying platform of the PEV Host. The PEV Host may then be moved to a second location where at least one PEV is removed from the PEV Host at the second location.

Variation 2 may include a method as set forth in Variation 1 wherein the PEVs may be of various widths.

Variation 3 may include a method as set forth in any of Variations 1-2 wherein the carry platform may include an electric charging station which may be constructed and arranged to provide an electrical charge to the PEV.

Variation 4 may include a method as set forth in any of Variations 1-3 wherein the carry platform may include a mechanical conveyor which may have individually rotating units which may be constructed and arranged to move the PEVs laterally along the carry platform.

Variation 5 may be a method as set forth in any of Variations 1-4 wherein the Host may further include a PEV lockdown and positioning system constructed and arranged to lock in the fore/aft and lateral positions of the PEVs on the Host.

Variation 6 may include a method as set forth in any of Variations 1-4 wherein the individually rotating units may be constructed and arranged to come into abutting contact with at least one tire of the PEV.

Variation 7 may include a method as set forth in any of Variations 1-6 wherein the PEV Host may further include a detection system which may be constructed and arranged to detect foreign objects on the PEV Host carry platform.

Variation 8 may include a method as set forth in any of Variations 1-7 wherein the step of moving a fully loaded PEV to the first location, removing at least one PEV from the PEV Host at the first location, laterally moving the remaining PEVs along the carry platform to compact the load and loading additional PEVs from the conveyor to the carry platform of the PEV Host may be repeated until a final dismemberment location is reached.

Variation 9 may include a method which may include first moving a Personal Electric Vehicle (PEV) Host to a first location wherein the PEV Host may include at least one PEV disposed on a carry platform. At least one PEV from the PEV Host may be removed at the first location. At least one PEV may be laterally moved across the carry platform in order to compact the load. Additionally, at least one PEV from the conveyor may be loaded onto the carrying platform of the PEV Host. Next, the PEV Host may be moved to a second location where at least one PEV from the PEV Host may be removed.

Variation 10 may include a method as set forth in Variation 9 wherein the PEVs may be of various widths.

Variation 11 may include a method as set forth in any of Variations 9-10 wherein the carry platform may include an electric charging station which may be constructed and arranged to provide an electrical charge to the PEV.

Variation 12 may include a method as set forth in any of Variations 9-11 wherein the carry platform may include a mechanical conveyor having individually rotating units which may be constructed and arranged to move PEVs laterally along the carry platform.

Variation 13 may include a method as set forth in any of Variations 9-12 wherein the Host may further include a PEV lockdown and positioning system which may be constructed and arranged to lock the PEV in the fore/aft and lateral positions on the Host.

Variation 14 may include a method as set forth in any of Variations 9-13 wherein the individually rotating units may be constructed and arranged to come into abutting contact with at least one tire of the PEV.

Variation 15 may include a method as set forth in any of Variations 9-14 wherein the PEV Host may further include a detection system which may be constructed and arranged to detect foreign objects on the PEV Host carry platform.

Variation 16 may include a method which may comprise providing a conveyor constructed and arranged to move a Personal Electric Vehicle (PEV). A fully loaded PEV Host may be moved to a first location wherein the PEV Host may include a carry platform. At least one PEV may be removed from the PEV Host at the first location. The remaining PEVs may be moved laterally along the carry platform in order to compact the load using a mechanical conveyor having individually rotating units which may be constructed and arranged to move PEVs laterally along the carry platform. Additional PEVs may be loaded from the conveyor to carrying platform of the PEV Host. Finally, the PEV Host may be moved to a second location where at least one PEV from the PEV Host may be removed.

Variation 17 may include a method as set forth in Variation 16 wherein the PEVs may be of various widths.

Variation 18 may include a method as set forth in any of Variations 16-17 wherein the carry platform may include an electric charging station which may be constructed and arranged to provide an electrical charge to the PEV.

Variation 19 may include a method as set forth in any of Variations 16-18 wherein the Host may further include a PEV lockdown and positioning system which may be constructed and arranged to lock the PEV in the fore/aft and lateral positions on the Host.

Variation 20 may include a method as set forth in any of Variations 16-19 wherein the steps of moving a fully loaded PEV Host to a first location; removing at least one PEV from the PEV Host at the first location; laterally moving the remaining PEVs along the carry platform to compact the load; and loading additional PEVs from the conveyor to the carrying platform of the PEV Host may be repeated until a final disembarkment location is reached.

The above description of select variations within the scope of the invention is merely illustrative in nature and, thus, variations or variants thereof are not to be regarded as a departure from the spirit and scope of the invention.

1. A method comprising:
providing a conveyer constructed and arranged to move a Personal Electric Vehicle (PEV);
moving a fully loaded PEV Host to a first location, wherein the PEV Host includes a carry platform;
removing at least one PEV from the PEV Host at the first location;
laterally moving the remaining PEVs along the carry platform to compact the load;
loading additional PEVs from the conveyer to the carrying platform of the PEV Host;
moving the PEV Host to a second location; and
removing at least one PEV from the PEV Host at the second location.

2. The method of claim 1 wherein the PEVs may be of various widths.

3. The method of claim 1 wherein the carry platform includes an electric changing station constructed and arranged to provide an electrical charge to the PEV.

4. The method of claim 1 wherein the carry platform includes a mechanical conveyer having individually rotating units constructed and arranged to move PEVs laterally along the carry platform.

5. The method of claim 4 wherein the Host further includes a PEV lockdown and positioning system constructed and arranged to lock in the fore/aft and lateral position of the PEVS on the Host.

6. The method of claim 4 wherein the individually rotating units are constructed and arranged to come into abutting contact with at least one tire of the PEV.

7. The method of claim 1 wherein the PEV Host further includes a detection system constructed and arranged to detect foreign objects on the PEV Host carry platform.

8. The method of claim 1 wherein the
moving a fully loaded PEV Host to a first location;
removing at least one PEV from the PEV Host at the first location;
laterally moving the remaining PEVs along the carry platform to compact the load; and
loading additional PEVs from the conveyer to the carrying platform of the PEV Host; are repeated until a final disembarkment location is reached.

9. A method comprising:
moving a Personal Electric Vehicle (PEV) Host to a first location, wherein the PEV Host includes at least one PEV disposed on a carry platform;
removing at least one PEV from the PEV Host at the first location;
laterally moving at least one PEV along the carry platform to compact the load;
loading at least one PEVs from the conveyer to the carrying platform of the PEV Host;
moving the PEV Host to a second location; and
removing at least one PEV from the PEV Host at the second location.

10. The method of claim 9 wherein the PEVs are of various widths.

11. The method of claim 9 wherein the carry platform includes an electric changing station constructed and arranged to provide an electrical charge to the PEV.

12. The method of claim 9 wherein the carry platform includes a mechanical conveyer having individually rotating units constructed and arranged to move PEVs laterally along the carry platform.

13. The method of claim 9 wherein the Host further includes a PEV lockdown and positioning system constructed and arranged to lock in the fore/aft and lateral position of the PEVS on the Host.

14. The method of claim 12 wherein the individually rotating units are constructed and arranged to come into abutting contact with at least one tire of the PEV.

15. The method of claim 9 wherein the PEV Host further includes a detection system constructed and arranged to detect foreign objects on the PEV Host carry platform.

16. A method comprising:
providing a conveyer constructed and arranged to move a Personal Electric Vehicle (PEV);
moving a fully loaded PEV Host to a first location, wherein the PEV Host includes a carry platform;
removing at least one PEV from the PEV Host at the first location;
laterally moving the remaining PEVs along the carry platform to compact the load using a mechanical conveyer having individually rotating units constructed and arranged to move PEVs laterally along the carry platform;
loading additional PEVs from the conveyer to the carrying platform of the PEV Host;
moving the PEV Host to a second location; and
removing at least one PEV from the PEV Host at the second location.

17. The method of claim 16 wherein the PEVs may be of various widths.

18. The method of claim 16 wherein the carry platform includes an electric charging station constructed and arranged to provide an electrical charge to the PEV.

19. The method of claim 16 wherein the Host further includes a PEV lockdown and positioning system constructed and arranged to lock the PEV in the fore/aft and lateral position of the PEVs on the Host.

20. The method of claim 16 wherein the:
moving a fully loaded PEV Host to a first location;
removing at least one PEV from the PEV Host at the first location;
laterally moving the remaining PEVs along the carry platform to compact the load; and
loading additional PEVs from the conveyer to the carrying platform of the PEV Host; are repeated until a final disembarkment location is reached.
